(19) United States
(12) Patent Application Publication
(10) Pub. No.: US 2021/0015077 A1
(43) Pub. Date: Jan. 21, 2021

(54) ELIZABETHAN COLLAR FOR COMPANION ANIMAL

(71) Applicant: JMA&H INC., Gyeonggi-do (KR)

(72) Inventor: Moon Seok KIM, Gyeonggi-do (KR)

(73) Assignees: JMA&H INC., Gyeonggi-do (KR); JMA&H INC., Gyeonggi-do (KR)

(21) Appl. No.: 17/040,330

(22) PCT Filed: Apr. 8, 2020
(86) PCT No.: PCT/KR2020/004775

§ 371 Date: Sep. 22, 2020

(30) Foreign Application Priority Data
Apr. 9, 2019 (KR) 10-2019-0041543
Nov. 21, 2019 (KR) 10-2019-0150796

(51) Int. Cl. A01K 15/04; A01K 13/00; A01K 27/00

(52) U.S. Cl. CPC A01K 15/04; A01K 27/002; A01K 13/006

(57) ABSTRACT

The present disclosure relates to an Elizabethan collar for a pet. According to the present disclosure, since it is possible to adjust the direction of the Elizabethan collar, it is possible to increase usability of the Elizabethan collar and to enable a pet to comfortably wear the Elizabethan collar while preventing the pet from easily taking off the Elizabethan collar.

### CROSS REFERENCE TO RELATED APPLICATION

This application claims priority from Korean Patent Application Nos. 10-2019-0041543 & 10-2019-0150796, filed on Apr. 9, 2019 & Nov. 21, 2019, which is hereby incorporated by reference for all purposes as if fully set forth herein.

### FIELD

The present disclosure relates to an Elizabethan collar for a pet improved from defects and side effects of existing Elizabethan collars that are used to prevent an injury from being disturbed when a pet recovers after a surgical procedure or operation.

### BACKGROUND

In general, Elizabethan collars that are made of various materials to be worn on the neck of pets are used to prevent pets from disturbing an injury or an operated portion, such as licking or scratching with claws the injury or the operated portion after a treatment or a surgical operation. However, since all types of Elizabethan collars have a shape that strangles the neck of pets, the Elizabethan collars block the visual field of pets or tighten up the neck of the pets wearing them. There are various side effects such as secondary damage to the feet or claws of pets that occurs when pets attempt to remove Elizabethan collars in order to remove stress due thereto. In particular, since cats are more severely stressed than dogs, cats severely resist or their health conditions gets worse, so it is difficult to keep an Elizabethan collar on cats after a treatment or a surgical operation in many cases.

Further, since existing Elizabethan collars are designed to face any one of the front and the rear, veterinarians have to recommend two or more Elizabethan collars or the guardians of pets have to purchase two or more Elizabethan collars, depending on the position of an injury of pets, which causes an economic load.

In detail, the present disclosure is characterized by increasing usability of Elizabethan collars that have to be used only in one direction in the related art by enabling the shape of an Elizabethan collar to change in accordance with the position and the degree of an injury of pets. Further, the present disclosure reduces stress and increases a treatment effect by enabling a pet to comfortably wear an Elizabethan color without the neck of the pet strangled and the Elizabethan collar removed by fastening the neck of clothes for pets and the neck contact portion of the Elizabethan collar to each other in order to remove the defect that when a pet wears an Elizabethan collar, the neck of the pet is strangled and the Elizabethan collar is removed by resistance of the pet.

### SUMMARY

The inventor(s), in order to solve the problems, has studied to develop an Elizabethan collar for pets that can be used in both directions of the front and the rear and can help quick recovery by protecting a treated or operated portion and decrease the stress due to strangling of a neck. As a result, the inventor(s) has found out that it is possible to minimize stress to pets because usability of an Elizabethan collar can be increased by adjusting the direction of the Elizabethan collar when manufacturing the Elizabethan collar such that the outer circumference of the Elizabethan collar can be adjusted, and an Elizabethan collar can be maintained even without strangling the neck of pets when the Elizabethan collar and a piece of clothing for pets are integrally manufactured as a single product, and has completed the present disclosure.

Accordingly, an objective of the present disclosure is to provide an Elizabethan collar 100 having an opening 10 formed inside to insert the head of a pet, and an adjustment cord 30 for adjusting the length of the outer edge 20 of the Elizabethan collar 100.

Another objective of the present disclosure is to provide an Elizabethan collar for a pet that includes a collar 101, a body part 200, and a connector 300 that connects the color 101 and the body part 200.

According to an aspect of the present disclosure, there is provided an Elizabethan collar 100 having an opening 10 formed inside to insert the head of a pet, and an adjustment cord 30 for adjusting the length of the outer edge 20 of the Elizabethan collar 100.

The term “Elizabethan collar” used herein means a device for protecting pets which is called an E-collar, a neck collar, a pet cone, etc., and the Elizabethan collar is used to prevent interference with recovery due to pets licking or scratching an injury or an operated portion after a treatment or an operation.

In an embodiment of the present disclosure, the opening 10 formed inside the collar is a part enabling the Elizabethan collar to be worn on a pet while passing the head of the pet therethrough, so the inner edge of the opening is made of an elastic fiber material (e.g., an elastic band) so that a pet does not feel uncomfortable when the Elizabethan collar is worn on the pet or removed.

In an embodiment of the present disclosure, the outer edge 20 of the collar has a polygonal shape with three or more sides or corners, or a circular shape.

Accordingly, since the Elizabethan collar 100 of the present disclosure is a plate-shaped product, when the Elizabethan collar 100 is unfolded on a space with a flat surface, it looks like a polygonal figure having a hole (opening) at the center and three or more sides (edges) or corners (e.g., a triangle, a rectangle, a pentagon, a hexagon, a heptagon, an octagon, etc.), or a circular figure.

In a detailed embodiment of the present disclosure, the Elizabethan collar 100 is deformed in a cone type in which the collar faces to the front from a pet, a reverse cone type or an inverted cone type in which the collar faces to the rear from a pet, or a flat type in which the collar is perpendicular to the axial direction of the body of a pet by adjusting the adjustment cord 30.

For example, when the Elizabethan collar 100 of the present disclosure is worn on the neck of a pet through the opening in the original unfolded shape and the adjustment cord 30 is not adjusted, the flat type in which the Elizabethan collar 100 is perpendicular to the axial direction of the body of the pet is applied.

When the Elizabethan collar 100 of the present disclosure is worn on the neck of a pet through the opening, the outer edge 20 of the Elizabethan collar 100 is inclined forward from a pet (toward the head of the pet, anterior direction), and then the outer edge is shortened and fixed in that position by pulling the adjustment cord 30, the cone type in which the Elizabethan collar faces to the front from a pet is naturally implemented.

The material of the adjustment cord 30 of the present disclosure is not limited, and for example, it may be an elastic material such as an elastic cord or a material with little elasticity such as a common shoelace.

The adjustment cord 30 may additionally have a fixing device to be able to adjust and fix the length of the outer edge of the Elizabethan collar 100. The fixing device may be, for example, a cord lock or a multi hole stopper (a triangle, a peanut shape, a rod shape, etc.), but is not limited thereto.

The operation position of the adjustment cord 30 may be on the outer edge 20 of the Elizabethan collar 100 or on the opening 10 that is supposed to come in contact with the neck of a pet.

On the other hand, when the Elizabethan collar 100 of the present disclosure is worn on the neck of a pet through the opening, the outer edge 20 of the Elizabethan collar 100 is inclined rearward from a pet (toward the tail of the pet, posterior direction), and then the outer edge is shortened and fixed in that position by pulling the string 30, the reverse cone type or the inverted cone type in which the Elizabethan collar faces to the rear from a pet is naturally implemented.

In an embodiment of the present disclosure, the Elizabethan collar has one or more folding portions 40 extending from the opening 10 to the outer edge 20. The number of the folding portions may be the same as or different from the sides or the corners of the outer edge, and at least four folding portions may be formed. Accordingly, for example, the outer edge of the Elizabethan collar may have a hexagonal shape and there may be one to six, or seven or more folding portions.

In a detailed embodiment of the present disclosure, the folding portions 40 may be grooves and/or sewn lines for easy folding.

In another embodiment of the present disclosure, the Elizabethan collar 100 has cut ends formed from the opening 10 to the outer edge 20.

When the Elizabethan collar 100 is cut from the opening to the outer edge, it is possible to put the Elizabethan collar laterally on the neck of a pet without passing the head of the pet through the opening, using the cut ends.

In another embodiment of the present disclosure, the cut ends are detachably attached. Accordingly, in order to put the Elizabethan collar on the neck of a pet, a user separates the cut ends, puts the Elizabethan collar on the neck of the pet through between the cut ends, and then connects the cut ends, whereby the Elizabethan collar is fixed not to be easily separated. In order to connect the cut ends, a belt, a Velcro tape, a button, a snap button, a buckle, a magnetic button, a strap (cord), etc. may be used, but the present disclosure is not limited thereto.

In an embodiment of the present disclosure, the Elizabethan collar 100 is made of medical linen, an operation cover, plastic, a textile fabric, knitted cloth, a nonwoven fabric, leather, a sponge, a cushion, or an expandable material, but is not limited thereto.

In another embodiment of the present disclosure, when the Elizabethan collar is made of a disposable material, it may be used as a disposable product that can be discarded or replaced with a new Elizabethan collar when it is contaminated with a secretion from an injury or an operated portion at an animal hospital. When the Elizabethan collar is made of a material that can be laundered or washed, it may be used as a multi-use product.

According to another embodiment of the present disclosure, there is provided a clothing type Elizabethan collar that includes a collar part 101, a body part 200, and a connector 300 that connects the color part 101 and the body part 200.

The collar part 101 of the present disclosure includes the Elizabethan collar 100 described above.

In an embodiment of the present disclosure, the body part 200 may be formed in a clothing type for a pet. When the body part 200 is a clothing type for a pet, a size adjuster is disposed on the dorsal part or the ventral part, whereby it is possible to adjust the size of the body part 200 in accordance with the kinds and body shapes of pets. A belt, a Velcro tape, a button, a snap button, a buckle, a magnetic button, a strap (cord), etc. may be used as the size adjuster, but the present disclosure is not limited thereto.

The body part 200 of the present disclosure is supposed to be worn on the part behind the neck of a pet and may have two holes ventrally formed between a neck and a waist to insert forelegs.

In another embodiment, when the body part 200 is supposed to cover even the rump from the neck of a pet, four holes may be ventrally formed to insert forelegs and hind legs.

In an embodiment of the present disclosure, when the body part 200 is supposed to cover the rump from the neck of a pet, a separate hole for inserting a tail may be formed. Alternatively, as shown in FIG. 2, when a fixing member 201 of the body part 200 is disposed on the back, a recessed V-shaped or U-shaped wedged cut may be formed at the rump portion of the body part to form a hole so that a tail can be naturally inserted when the fixing member 201 is fastened and the body part is worn.

In the present disclosure, the body part 200 of the clothing type Elizabethan collar may be made of medical linen or an operation cover.

In another embodiment of the present disclosure, the body part 200 may be formed in a harness type for a pet. A harness, unlike a lead, generally has a T-shaped breast strap or a T-shaped breast collar and straps or bands extending over the back from the left and right sides of the T-shaped strap or the T-shaped collar. Further, fastening members (e.g., a two-way/snap buckle) that can fasten the straps or the bands extending from both sides are disposed at the ends of the straps or the bands extending over the back so that the breast strap can be fixed to be fitted to the body of a pet. The breast strap is classified into an X-type and an H-type, depending on the shapes seen from above.

In an embodiment of the present disclosure, the collar part 101 of the clothing type Elizabethan collar has an opening at the center, so it is possible to put the collar part 101 on the neck of a pet by passing the head of the pet through the opening.

In another embodiment of the present disclosure, the collar part 101 of the clothing type Elizabethan collar is cut at a portion, so it is possible to put the collar part 101 on the neck of a pet through the cut portion. Both ends of the cut portion can be attached to each other, so it is possible to attach and fix both ends of the cut portion to each other after putting the collar part on the neck of a pet through the cut portion.

In the present disclosure, the collar part 101 of the clothing type Elizabethan collar may be a cone type in which the collar faces the front, a flat type in which the collar is perpendicular to the axis of the body of a pet, and a reverse cone type in which the collar faces the rear when a pet wears the Elizabethan collar. The types are changed by adjusting the length of the inner edge or the outer edge of the collar part and the length may be adjusted, for example, by inserting an elastic cord in the edge of the collar, but the present disclosure is not limited thereto.

It is possible to manufacture the collar part 101 of the present disclosure such that the circumference of the neck contact portion inside the collar part 101, the size of the collar part 101, and the length of the outer edge are fitted to the body shapes of pets including the breeds.

In the clothing type Elizabethan collar of the present disclosure, as described above, the collar part 101, the body part 200, and the connector 300 are integrally connected. Since common Elizabethan collars of the related art have only the collar part 101 of the present disclosure, the load of the entire collar is applied to the neck contact portion, so pets feel strong strangling on the neck. However, since the collar part 101 is connected to the body part 200 in the Elizabethan collar of the present disclosure, the load of the collar part 101 is not only applied to the neck of a pet, but also distributed to the entire body through the body part 200. Accordingly, pets wearing the Elizabethan collar of the present disclosure are not stressed due to strangling of the neck, so patient compliance is very good.

In an embodiment of the present disclosure, the body part of the clothing type Elizabethan collar has the fixing member 201 on a side to be easily worn on and removed from a pet. The fixing member 201 may be a snap button, a buckle, a magnetic button, a zipper, or a Velcro tape, but it not limited thereto, and the clothing type Elizabethan collar of the present disclosure can be worn on and removed from the body of a pet by locking or unlocking the fixing member 201.

In an embodiment of the present disclosure, the connector 300 of the clothing type Elizabethan collar connects the collar part 101 and the body part 200 by sewing, a button, a snap button, a buckle, a magnetic button, a zipper, or a Velcro tape, but is not limited thereto, and it would be easily understood by those skilled in the art that all types of fastening tools that can be used in this field can be used.

In another embodiment of the present disclosure, the connector 300 is made of an elastic fiber material. The elastic fiber material may be a circular knit, and in detail, there are single jersey, rib, interlock, French Terry, minizurry, etc., but is not limited thereto, and all kinds of elastic fiber materials that can be used in this field can be used.

In another embodiment of the present disclosure, the connector 300 can be connected and disconnected, so the neck contact portion of the collar part 101 and the body part 200 can be coupled and decoupled.

In an embodiment of the present disclosure, the connector 300 may be made of an elastic material to improve wearing comfort.

In another embodiment of the present disclosure, the connector 300 may be made of a non-elastic material.

Whether to use an elastic material or a non-elastic material for the connector 300 may depend on the degree of resistance and the kind of atlantoaxis on which the Elizabethan collar of the present disclosure is worn. For example, in the case of high resistance of an atlantoaxis and in the case of a cat having a flexible body, using a non-elastic material for the connector 300 is preferable because it is difficult to remove the Elizabethan collar.

The material of the collar part 101 of the present disclosure may be plastic, a textile fabric, knitted cloth, a nonwoven fabric, leather, a sponge, a cushion, an expandable material, a combination thereof, but is not limited thereto.

Further, in an embodiment of the present disclosure, when the clothing type Elizabethan collar is made of a disposable material, it may be used as a disposable product that can be discarded or replaced with a new Elizabethan collar when it is contaminated with a secretion from an injury or an operated portion at an animal hospital. When the Elizabethan collar is made of a material that can be laundered or washed, it may be used as a multi-use product.

The present disclosure relates to an Elizabethan collar for a pet. According to the present disclosure, since it is possible to adjust the direction of the Elizabethan collar, it is possible to increase usability of the Elizabethan collar and to enable a pet to comfortably wear the Elizabethan collar while preventing the pet from easily taking off the Elizabethan collar.

### BRIEF DESCRIPTION OF THE DRAWINGS

The above and other aspects, features and advantages of the present disclosure will be more apparent from the following detailed description taken in conjunction with the accompanying drawings, in which:

FIGS. 1A, 1B and 1C are views showing a cat wearing a Elizabethan collar 100 of the present disclosure, in which FIG. 1A shows a flat type, FIG. 1B shows a cone type, and FIG. 1C shows a reverse cone type;

FIG. 2 is a view showing the state in which a fixing member 201 of a body part of a clothing type Elizabethan collar of the present disclosure is locked;

FIG. 3 is a view showing the state in which the fixing member 201 of the body part 200 of a clothing type Elizabethan collar of the present disclosure is unlocked;

FIGS. 4A, 4B and 4C are views showing a cat wearing a clothing type Elizabethan collar of the present disclosure. The collar part 101 can be changed into a flat type (FIG. 4A), a cone type (FIG. 4B), and a reverse cone type (FIG. 4C); and

FIGS. 5A, 5B and 5C shows a cat wearing the clothing type Elizabethan collar of the present disclosure, in which the fixing member 201 is disposed not on the back, but on the belly, as an example, in which the collar part 101 can be changed into a flat type (FIG. 5A), a cone type (FIG. 5B), and a reverse cone type (FIG. 5C).

### DETAILED DESCRIPTION

Hereinafter, exemplary embodiments of the present disclosure will be described in detail with reference to the accompanying drawings.

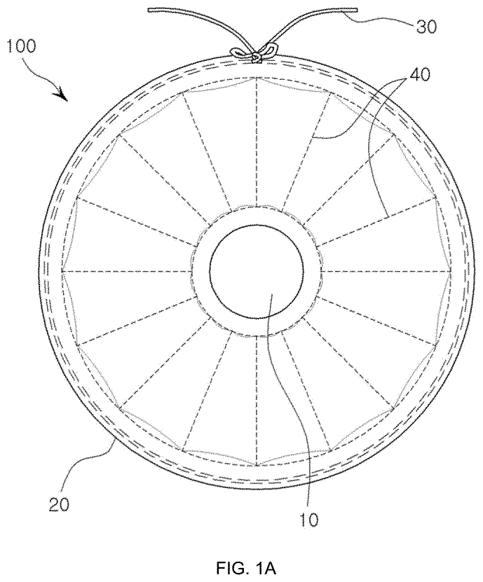

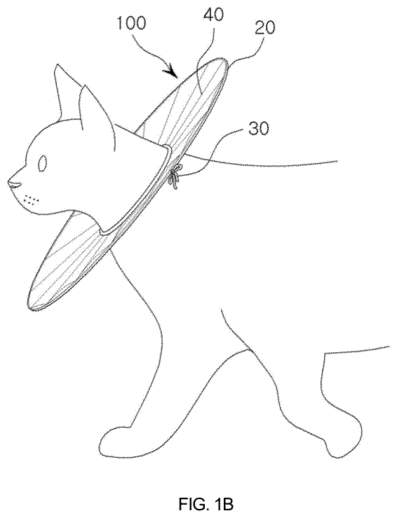

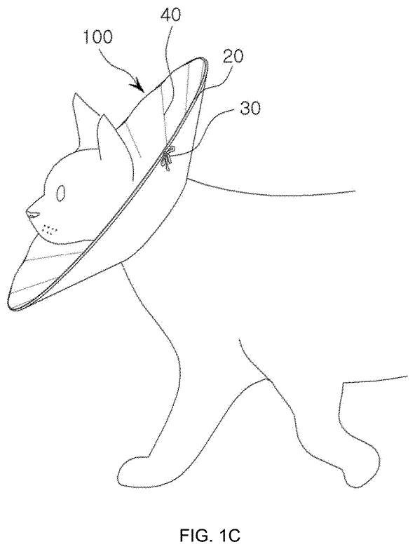

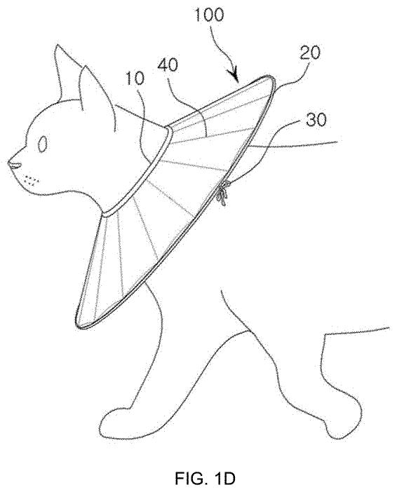

FIGS. 1A to 1C are views showing a cat wearing the Elizabethan collar 100 of the present disclosure. FIG. 1A shows a flat type, FIG. 1B shows a cone type, and FIG. 1C shows a reverse cone type.

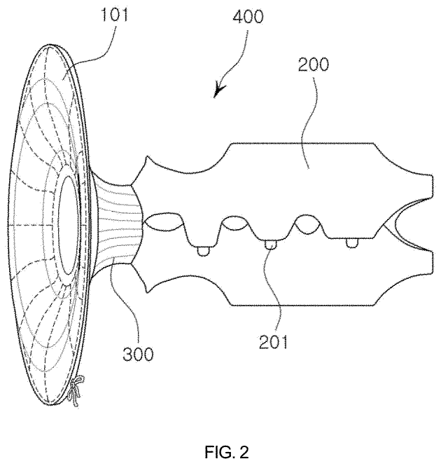

FIG. 2 is a view showing the state in which a fixing member 201 of a body part of a clothing type Elizabethan collar of the present disclosure is locked.

The portion of the Elizabethan collar that is supposed to come in contact with the neck of a pet and the neck of the clothing are combined in FIG. 2, in which the neck (connector 300) is made of a soft and elastic material (e.g., rib) to prevent the neck of a pet from being strangled and to easily put on and remove the Elizabethan collar to be fitted to the kinds of pets and the sizes of the skull of pets. In order to connect the neck of the clothing, all kinds of methods such as sewing, a button, a Velcro tape, a zipper, etc. can be used. The neck is integrally formed, so it is not removed even if a pet scratches or kicks it with the forelegs or hind legs.

A Velcro tape is applied to the fixing member 201 on the back of the body part of the clothing for a pet in FIG. 2 so that the size and the degree of contact can be adjusted. The clothing 200 is fabricated to be adjusted to be fitted well to the body shapes of pets by using various functional fibers having the spandex function, and can be fabricated in individual sizes to be suitable for the breeds, weight, and sizes such as bust widths of dogs and cats.

The Elizabethan collar part 101 shown in FIG. 2 is made of a soft cushion material, so the wearing comfort is improved to be light and soft. The material in the cushion may be a sponge, cotton, silicon, etc.

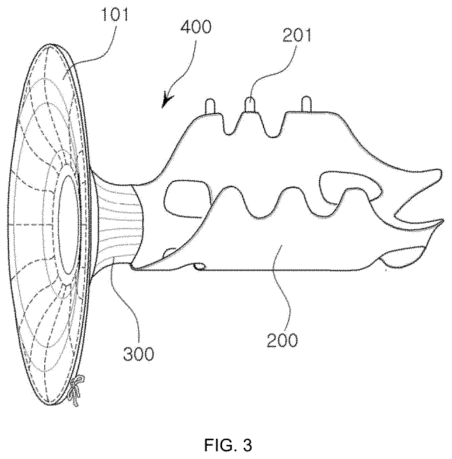

FIG. 3 is a view showing the state in which the fixing member 201 of the body part 200 of a clothing type Elizabethan collar of the present disclosure is unlocked.

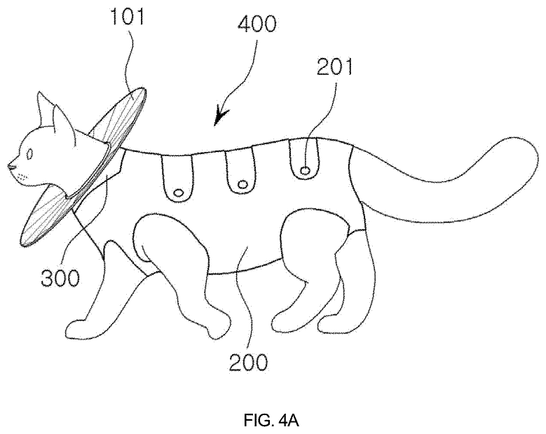

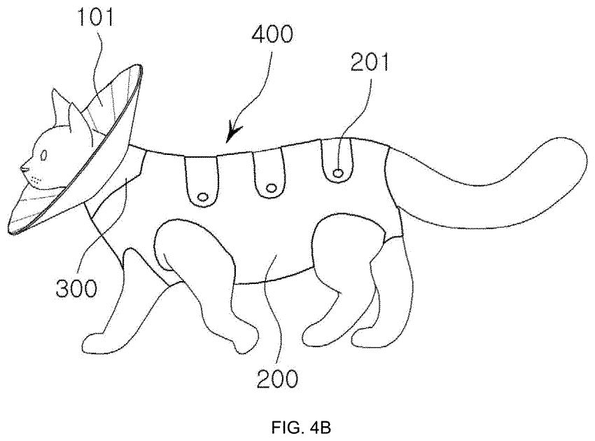

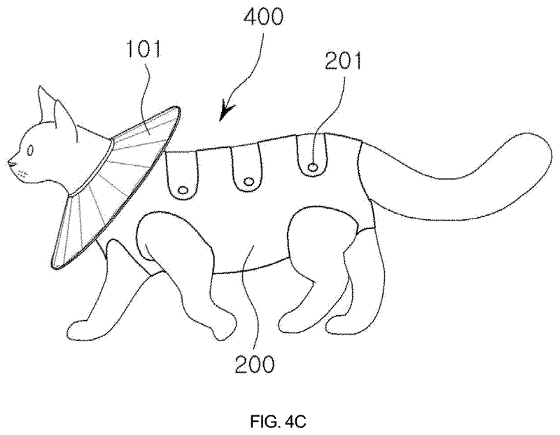

FIGS. 4A to 4C show the collar part 101 of the clothing type Elizabethan collar of the present disclosure that is changed into a cone type, a flat type, and a reverse cone type.

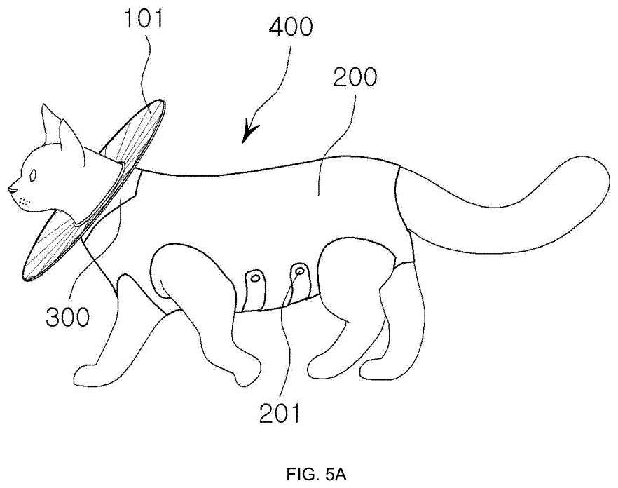

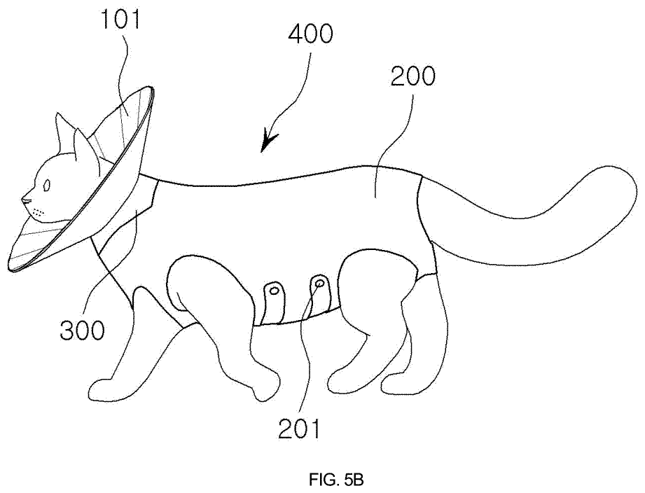

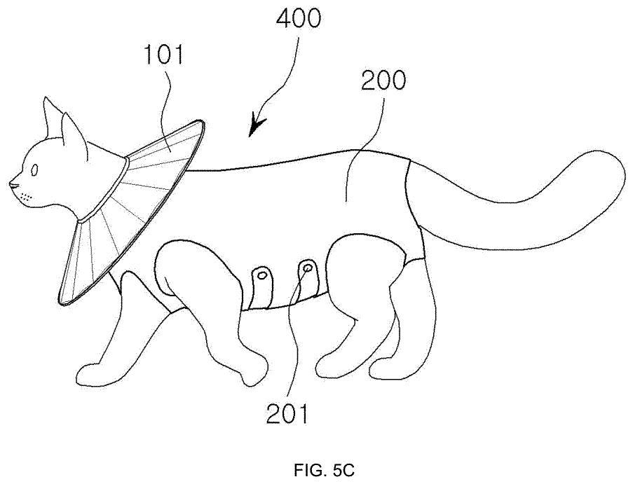

FIGS. 5A to 5C shows a cat wearing the clothing type Elizabethan collar of the present disclosure, in which the fixing member 201 is disposed not on the back, but on the belly, as an example. The collar part 101 can be changed into a flat type (FIG. 5A), a cone type (FIG. 5B), and a reverse cone type (FIG. 5C).

### DESCRIPTION OF SYMBOLS

opening 10
outer edge 20
adjustment cord 30
folding portion 40
Elizabethan collar 100
collar part 101
body part 200
fixing member 201
connector 300
clothing type Elizabethan collar 400

1-15. (canceled)

16. An Elizabethan collar having an opening formed inside to insert the head of a pet, and an adjustment cord for adjusting the length of an outer edge of the Elizabethan collar.

17. The Elizabethan collar of claim 16, wherein the outer edge of the collar has a polygonal shape having three or more sides or corners, or a circular shape.

18. The Elizabethan collar of claim 16, wherein the Elizabethan collar is deformed in a cone type in which the collar faces to the front from a pet, a reverse cone type in which the collar faces to the rear from a pet, or a flat type in which the collar is perpendicular to an axial direction of the body of a pet by adjusting the adjustment cord.

19. The Elizabethan collar of claim 16, wherein the Elizabethan collar has one or more folding portions extending from the opening to the outer edge.

20. The Elizabethan collar of claim 16, wherein the Elizabethan collar has cut ends formed from the opening to the outer edge.

21. The Elizabethan collar of claim 20, wherein the cut ends are detachably attached.

22. The Elizabethan collar of claim 16, wherein the Elizabethan collar is made of plastic, a textile fabric, knitted cloth, a nonwoven fabric, leather, a sponge, a cushion, or an expandable material.

23. The Elizabethan collar of claim 16, wherein the Elizabethan collar is a disposable product.

24. A clothing type Elizabethan collar comprising: a collar part including the Elizabethan collar of claim; a body part; and a connector connecting the collar part and the body part.

25. The clothing type Elizabethan collar of claim 24, wherein the body part is formed in a clothing type for a pet.

26. The clothing type Elizabethan collar of claim 24, wherein the body part is formed in a harness type for a pet.

27. The clothing type Elizabethan collar of claim 24, wherein the connector connects the collar part and the body part using sewing, a button, a snap button, a buckle, a magnetic button, a zipper, or a Velcro tape.

28. The clothing type Elizabethan collar of claim 24, wherein the connector can be connected and disconnected, so a neck contact portion of the collar part and the body part can be coupled and decoupled.

29. The clothing type Elizabethan collar of claim 24, wherein the connector is made of an elastic or non-elastic material.

30. The clothing type Elizabethan collar of claim 24, wherein the clothing type Elizabethan collar is a disposable product.
